(19) United States
(12) Patent Application Publication
(10) Pub. No.: US 2024/0348614 A1
(43) Pub. Date: Oct. 17, 2024

(54) CONTROL DEVICE AND CONTROL METHOD

(71) Applicant: FANUC CORPORATION, Minamitsuru-gun, Yamanashi (JP)

(72) Inventor: Kazuya GOTO, Yamanashi (JP)

(21) Appl. No.: 18/701,724

(22) PCT Filed: Nov. 19, 2021
(86) PCT No.: PCT/JP2021/042642

§ 371 Date: Apr. 16, 2024

(51) Int. Cl. H04L 9/40; G05B 19/4155

(52) U.S. Cl. CPC H04L 63/10; G05B 19/4155; G05B 2219/31449

(57) ABSTRACT

A control device comprises: a measurement unit that measures the physical state of at least one electronic component to measure the temperature of a representative part thereof; a recording unit that records a model wave of the physical state of the electronic component, and the temperature of the representative part at the time of recording the model wave as a reference temperature; a correction unit that corrects the model wave based on the temperature of the representative part and the reference temperature; and a detection unit that adds up, at regular intervals, an absolute value of a difference between the measured physical state of the electronic component and the physical state of the corrected model wave, and determines whether or not the added value exceeds a threshold value for determining an unauthorized access that imposes excessive loads on resources to disturb operation of the control device or network.

### TECHNICAL FIELD

The present invention relates to a control device and a control method.

### BACKGROUND ART

Recently, the application range of network equipment has been expanding due to the spread of IoT (Internet of Things). Together with the expansion, cases of unauthorized access due to vulnerability of security are proliferating.

In order to prevent such unauthorized access, security is ensured by applying the latest patch to security vulnerability that has been found.

In this regard, there is known a technology of, in order to determine whether at least one suspicious point indicating malicious network content is included in received PDF network content, inspecting the PDF network content, providing the PDF network content which is determined to include at least one suspicious point to at least one virtual machine, and analyzing a response received from the at least one virtual machine to verify whether the PDF network content determined to include the at least one suspicious point includes malicious network content. See, for example, Patent Document 1.

### CITATION LIST

### Patent Document

Patent Document 1: Japanese Unexamined Patent Application (Translation of PCT Application), Publication No. 2014-504765

### DISCLOSURE OF THE INVENTION

### Problems to be Solved by the Invention

Since new means for unauthorized access constantly appears, a state exists in which security cannot be ensured for unrecognized vulnerability.

Further, since many control devices and the like for factories are used for a long time, they may continue to be used in a state in which security measures applied at the time of introduction have become insufficient as time has passed.

Therefore, when unknown vulnerability and vulnerability of insufficient security measures are utilized to disturb operation of a control device or a network by imposing an excessive load on resources, for example, like a DOS attack, stable operation of the control device or the system may be disturbed.

Therefore, it is desired to easily detect unauthorized access that imposes an excessive load on resources so as to disturb operation of a control device or a network, such as a DOS attack.

### Means for Solving the Problems

One aspect of a control device of the present disclosure is a control device capable of controlling an industrial machine and connecting to an external device, the control device including: a measurement unit configured to measure a physical state of at least one electronic component in measurement cycles and measures temperature of a representative part set in advance; a recording unit configured to record physical states of the electronic component during a period of execution of an arbitrary operation program and/or during standby in a normal state in association with the measurement cycles as a model waveform, and record the temperature of the representative part measured at time of recording the model waveform, as a reference temperature; a correction unit configured to correct, during the period of execution of the arbitrary operation program or during the standby, the model waveform of the electronic component recorded, based on the temperature of the representative part measured by the measurement unit and the reference temperature; and a detection unit configured to add up absolute values of differences between the physical states of the electronic component measured in association with the measurement cycles by the measurement unit and physical states of the model waveform corrected by the correction unit, the physical states corresponding to the measurement cycles in which the physical states of the electronic component have been measured, at each regular interval during the period of execution of the arbitrary operation program or during the standby, and determine whether or not an added-up value exceeds a determination threshold set in advance in relation to unauthorized access that disturbs operation of the control device or a network by imposing an excessive load on resources.

One aspect of a control method of the present disclosure is method for controlling an industrial machine by a control device capable of connecting to an external device, the method including: a measurement step of measuring a physical state of at least one electronic component in measurement cycles and measuring temperature of a representative part set in advance; a recording step of recording physical states of the electronic component during a period of execution of an arbitrary operation program and/or during standby in a normal state in association with the measurement cycles as a model waveform, and recording the temperature of the representative part measured at time of recording the model waveform, as a reference temperature; a correction step of correcting the recorded model waveform of the electronic component during the period of execution of the arbitrary operation program or during the standby, based on the measured temperature of the representative part and the reference temperature; and a detection step of adding up absolute values of differences between the physical states of the electronic component measured in association with the measurement cycles and physical states of the corrected model waveform, the physical states corresponding to the measurement cycles in which the physical states of the electronic component have been measured, at each regular interval during the period of execution of the arbitrary operation program or during the standby, and determining whether or not an added-up value exceeds a determination threshold set in advance in relation to unauthorized access that disturbs operation of the control device or a network by imposing an excessive load on resources.

### Effects of the Invention

According to one aspect, it is possible to easily detect unauthorized access that disturbs operation of a control device or a network by imposing an excessive load on resources, such as a DOS attack.

### BRIEF DESCRIPTION OF THE DRAWINGS

FIG. 1 is a diagram showing a functional configuration example of a control system according to one embodiment;

FIG. 2 is a diagram showing a functional configuration example of a CPU;

FIG. 3 is a diagram showing an example of a relationship between current consumption of the CPU and temperature during a period of execution of a machining program;

FIG. 4 is a diagram showing an example of the current consumption of the CPU in the case of being attacked by unauthorized access such as a Dos attack during the period of execution of the machining program;

FIG. 5 is a flowchart illustrating a detection process of a numerical control device; and

FIG. 6 is a diagram showing an example of a model waveform during standby.

### PREFERRED MODE FOR CARRYING OUT THE INVENTION

### One Embodiment

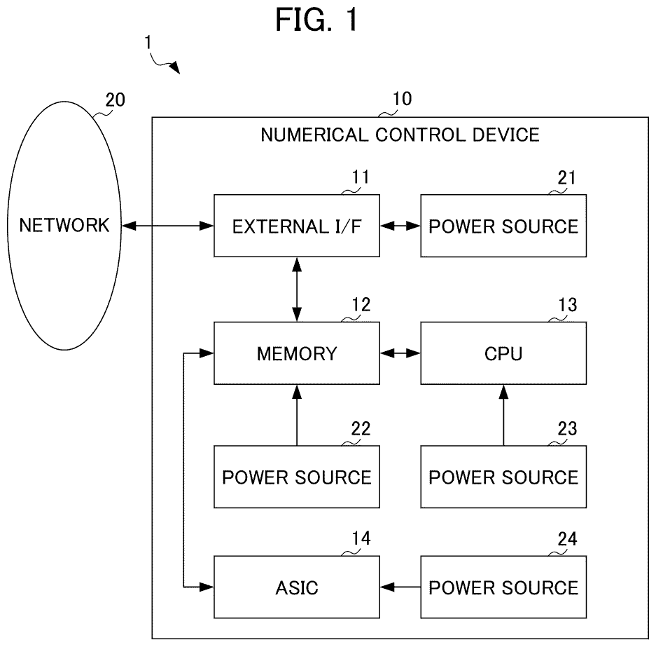

FIG. 1 is a diagram showing a functional configuration example of a control system according to one embodiment. Here, a machine tool and a numerical control device are exemplified as an industrial machine and a control device, respectively. The present invention is not limited to a machine tool and a numerical control device but is applicable to, for example, industrial machines such as an injection molding machine, an industrial robot, and a service robot, and a robot control device for controlling an industrial robot or the like.

In the present embodiment, a machining program for the numerical control device to cause the machine tool to operate will be described as an example of an operation program. It should be noted that the same description is applicable to a robot program or the like for a robot control device to cause an industrial robot or the like to operate.

As shown in FIG. 1, a control system 1 includes a numerical control device 10 and a network 20.

The numerical control device 10 is connected to the network 20 such as a LAN (local area network) or the Internet. In this case, the numerical control device 10 is provided with an external I/F (interface) 11 described later for communicating with the network 20 via such connection.

### <Numerical Control Device 10>

The numerical control device 10 is a numerical control device that is well known to one skilled in the art. For example, the numerical control device 10 generates an instruction based on a machining program acquired in advance from a CAD/CAM device or the like not shown, and outputs the generated instruction to a machine tool not shown. Thereby, the numerical control device 10 controls operation of the machine tool not shown. When the machine tool not shown is a robot or the like, the numerical control device 10 may be a robot control device or the like.

As shown in FIG. 1, the numerical control device 10 includes an external I/F 11, a memory 12, a CPU (central processing unit) 13, an ASIC (application specific integrated circuit) 14, and power sources 21 to 24.

The external I/F 11 is, for example, a well-known network interface, and performs asynchronous communication for collection of data of an operation state of the machine tool not shown, alarms/warnings, and the like with the network 20.

The memory 12 is a storage unit such as a ROM (read-only memory), a RAM (random access memory), an HDD (hard disk drive), and the like. In the memory 12, an operating system, application programs, the machining program, and the like to be executed by the CPU 13 described later are stored.

In the memory 12, as a recording unit, physical states (for example, current consumptions) of at least one electronic component such as the CPU 13 described later measured by a measurement unit 130 described later during a period of execution of the arbitrary machining program and/or during standby in a normal state of not being attacked by unauthorized access that disturbs operation of the numerical control device 10 or the network 20 by imposing an excessive load on resources, such as a Dos attack, are recorded in association with measurement cycles (hereinafter also referred to as “sampling cycles”) of the measurement unit 130 as a model waveform, in advance. Hereinafter, “unauthorized access that disturbs operation of the numerical control device 10 or the network 20 by imposing an excessive load on resources, such as a Dos attack” will be referred to as “unauthorized access such as a DOS attack” for short unless otherwise specified.

Further, the temperature of a representative part of the numerical control device 10 set in advance, which has been measured by the measurement unit 130 at the time of recording the model waveform of the physical state of the electronic component may be recorded in the memory 12 as a reference temperature. The representative part may be, for example, the electronic component such as the CPU 13 described later or a substrate on which the electronic component is arranged. Or alternatively, the representative part may be a part that is not affected by unauthorized access such as a DOS attack, such as a sequence control IC for turning on/off the power sources 21 to 24 described later, a voltage monitoring circuit, an analog circuit for AD/DA conversion or the like, or a nonvolatile memory in which only initial settings are stored.

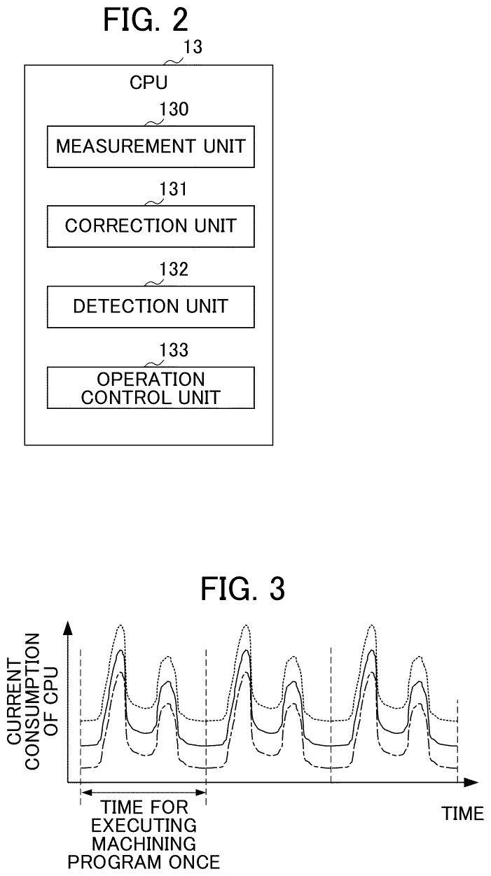

The CPU 13 is a well-known processor and is a processor that performs overall control of the numerical control device 10. The CPU 13 reads out a system program and an application program that are stored in the memory 12, via a bus and controls the whole numerical control device 10 according to the system program and the application program. Thereby, the CPU 13 is configured to realize the functions of the measurement unit 130, a correction unit 131, a detection unit 132, and an operation control unit 133 as shown in FIG. 2.

The measurement unit 130 measures the physical state of the at least one electronic component in sampling cycles and measures the temperature of the representative part of the numerical control device 10 set in advance.

Hereinafter, description will be made, with the CPU 13 and the current consumption of the CPU 13 as the electronic component and the physical state of the electronic component, respectively. The same description as the case of the current consumption of the CPU 13 is applicable to electronic components such as the external I/F 11, the memory 12, and the ASIC 14, and the physical states of the electronic components, such as power consumption and junction temperature, as described later.

Specifically, for example, the measurement unit 130 measures the current consumption of the CPU 13 as the physical state of the CPU 13 in sampling cycles, using an ammeter not shown, which is arranged on the power source 23 described later. The measurement unit 130 outputs the measured current consumptions of the CPU 13 to the detection unit 132 described later. The measurement unit 130 may measure the current consumption of the external I/F 11, the memory 12, and the ASIC 14 described later, using ammeters not shown, which are arranged on the power sources 21, 22, and 24 described later, respectively.

Further, the measurement unit 130 measures the temperature of the representative part of the numerical control device 10, using a temperature sensor (not shown) or the like arranged on the representative part of the numerical control device 10 set in advance. Then, the measurement unit 130 records the temperature of the representative part of the numerical control device 10 measured at the time of recording the model waveform of the current consumption of the CPU 13 to the memory 12 as a reference temperature.

During the period of execution of the arbitrary machining program or during standby, the correction unit 131 corrects the model waveform of the CPU 13 recorded in the memory 12 based on the temperature of the representative part of the numerical control device 10 measured by the measurement unit 130 and the reference temperature recorded in the memory 12.

FIG. 3 is a diagram showing an example of a relationship between the current consumption of the CPU 13 and temperature during the period of execution of the machining program. In FIG. 3, a model waveform of the current consumption of the CPU 13 in the normal state at the reference temperature is indicated by a solid line; a model waveform of the current consumption of the CPU 13 in the normal state when the temperature is rising is indicated by a broken line; and a model waveform of the current consumption of the CPU 13 when the temperature is falling is indicated by a long dashed short dashed line.

As shown in FIG. 3, in the case of being in the normal state, since the numerical control device 10 repeatedly executes the machining program for the same part machining, for the machine tool not shown, the current consumption of the CPU 13 of the numerical control device 10 repeats similar temporal fluctuation.

When the temperature of the representative part of the numerical control device 10 rises relative to the reference temperature, however, the overall model waveform of the current consumption of the CPU 13 also rises as shown in FIG. 3. Further, when the temperature of the representative part of the numerical control device 10 falls relative to the reference temperature, the overall model waveform of the current consumption of the CPU 13 also falls. That is, when a deviation from the model waveform of the current consumption of the CPU 13 in the normal state at the reference temperature increases due to temperature change, it becomes difficult to distinguish from increase/decrease in the current consumption of the CPU 13 due to unauthorized access such as a DOS attack. In such a case, the detection unit 132 described later mistakenly detects access as unauthorized access such as a DoS attack regardless of being in the normal state.

Therefore, based on the temperature of the representative part of the numerical control device 10 measured by the measurement unit 130 and the reference temperature recorded in the memory 12, the correction unit 131 corrects the model waveform of the current consumption of the CPU 13 in the normal state at the reference temperature to a model waveform of the current consumption of the CPU 13 in the normal state at the measured temperature of the representative part of the numerical control device 10. Since a well-known method can be used for correction of the model waveform by the correction unit 131, detailed description thereof will be omitted.

Thereby, it is possible to prevent erroneous determination by the detection unit 132 described later.

The detection unit 132 adds up absolute values of differences between physical states of the electronic component measured by the measurement unit 130 in association with sampling cycles, during a period of execution of the machining program or during standby, and physical states of the model waveform corrected by the correction unit 131, the physical states corresponding to the sampling cycles in which the physical states of the electronic component have been measured, at each regular interval during period of execution of the machining program or during standby, and determines whether an added-up value exceeds a determination threshold set in advance in relation to unauthorized access such as a DOS attack.

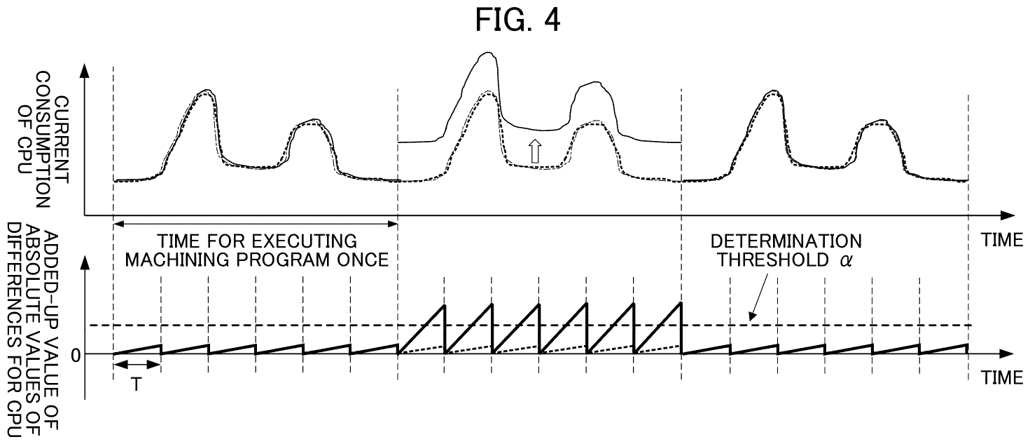

FIG. 4 is a diagram showing an example of the current consumption of the CPU 13 in the case of being attacked by unauthorized access such as a Dos attack during the period of execution of the machining program.

The upper part of FIG. 4 shows current consumptions of the CPU 13 measured in association with sampling cycles. In the upper part of FIG. 4, the corrected model waveform of the current consumption of the CPU 13 in the normal state is indicated by a broken line; the current consumption of the CPU 13 in the normal state is indicated by a long dashed short dashed line; and the current consumption of the CPU 13 in the case of being attacked by unauthorized access such as a Dos attack is indicated by a solid line. In the upper part of FIG. 4, the vertical axis indicates the current consumption of the CPU 13, and the horizontal axis indicates time.

The lower part of FIG. 4 shows an added-up value obtained by adding up absolute values of differences between measured current consumptions of the CPU 13 and current consumptions of the corrected model waveform, which are shown in the upper part of FIG. 4, at each regular interval during period of execution of the machining program. Further, in the lower part of FIG. 4, an added-up value obtained by adding up absolute values of differences between current consumptions of the CPU 13 in the normal state and the corrected current consumptions of the model waveform are indicated by a broken line; and an added-up value obtained by adding up absolute values of differences between current consumptions of the CPU 13 in the case of being attacked by the unauthorized access such as a DOS attack and current consumptions of the corrected model waveform is indicated by a solid line.

FIG. 4 shows a case of being attacked by the unauthorized access such as a DOS attack during execution time of the machining program (machining time) shown in the center.

As shown in the lower part of FIG. 4, the detection unit 132 adds up absolute values of differences between the current consumptions of the CPU 13 measured by the measurement unit 130 in association with sampling cycles during a period of execution of the machining program and current consumptions of the model waveform of the current consumption of the CPU 13 corrected by the correction unit 131, the current consumptions corresponding to the measurement cycles in which the current consumptions have been measured, at each regular interval T during execution time of the machining program (the machining time). That is, when the numerical control device 10 is being attacked by unauthorized access such as a Dos attack, the processing load on the CPU 13 increases, the current consumption of the CPU 13 changes, and the temperature of representative part of the numerical control device 10 also changes. Therefore, in order to detect unauthorized access such as a Dos attack utilizing the load fluctuation of the hardware of the CPU 13, the detection unit 132 calculates an added-up value obtained by adding up absolute values of differences between the current consumptions of the CPU 13 of the corrected model waveform (in the normal state) and the measured current consumptions of the CPU 13.

The detection unit 132 resets time of addition and the added-up value to “0” at each regular interval T.

Thereby, the detection unit 132 can prevent erroneous determination due to addition of minute errors.

Then, the detection unit 132 determines whether the added-up value exceeds a determination threshold α set in advance in relation to unauthorized access such as a DoS attack. If the added-up value exceeds the determination threshold α, the detection unit 132 determines that the numerical control device 10 is being attacked by unauthorized access such as a DOS attack.

For example, if the numerical control device 10 is receiving excessive access or the like in the execution time (the machining time) of the machining program shown in the center in FIG. 4, the processing load on the CPU 13 increases, and the current consumption of the CPU 13 increases. Thereby, the added-up value exceeds the determination threshold α. Thereby, the detection unit 132 can determine that the numerical control device 10 is being attacked by unauthorized access such as a DOS attack.

Further, if an excessive processing load is imposed on the CPU 13 by the numerical control device 10 receiving excessive access and the like during the execution time (the machining time), the processing of the CPU 13 is delayed, for example, due to lack of free space of the memory 12, the current consumption of the CPU 13 decreases, and the temperature of the representative part of the numerical control device 10 also decreases. If the added-up value for the CPU 13 exceeds the determination threshold α in such a case, the detection unit 132 can determine that the numerical control device 10 is being attacked by unauthorized access such as a DOS attack.

Further, even if the numerical control device 10 receives excessive access and the like for a period shorter than the execution time (the machining time), the processing load on the CPU 13 increases, and the current consumption of the CPU 13 primarily increases (or decreases). Therefore, when the added-up value for the CPU 13 exceeds the determination threshold α, the detection unit 132 can determine that the numerical control device 10 is being attacked by unauthorized access such as a Dos attack.

It is preferable that the values of the determination threshold α and the regular interval T are determined so that, during execution of the machining program, the detection unit 132 does not determine normal asynchronous communication or the like as unauthorized access such as a Dos attack.

For example, the operation control unit 133 generates an instruction based on the machining program, outputs the generated instruction to the machine tool not shown, and, when the detection unit 132 makes a determination of unauthorized access such as a Dos attack, shuts off the numerical control device 10 from the network 20. Then, the operation control unit 133 stops the machining program and may record a log to the effect that the unauthorized access such as a Dos attack has been detected, in the memory 12. Further, the operation control unit 133 may display (notify) a message or the like that the unauthorized access has been detected, on a display unit of a liquid crystal display or the like included in the numerical control device 10 or the machine tool (not shown).

The ASIC 14 is an integrated circuit for specific application and, for example, performs specific processing in the numerical control device 10.

The power sources 21 to 24 supply power to the external I/F 11, the memory 12, the CPU 13, and the ASIC 14, respectively. The power sources 21 to 24 may include an ammeter not shown for measuring current consumption and may output the measured current consumption to the measurement unit 130.

### <Detection Process of Numerical Control Device 10>

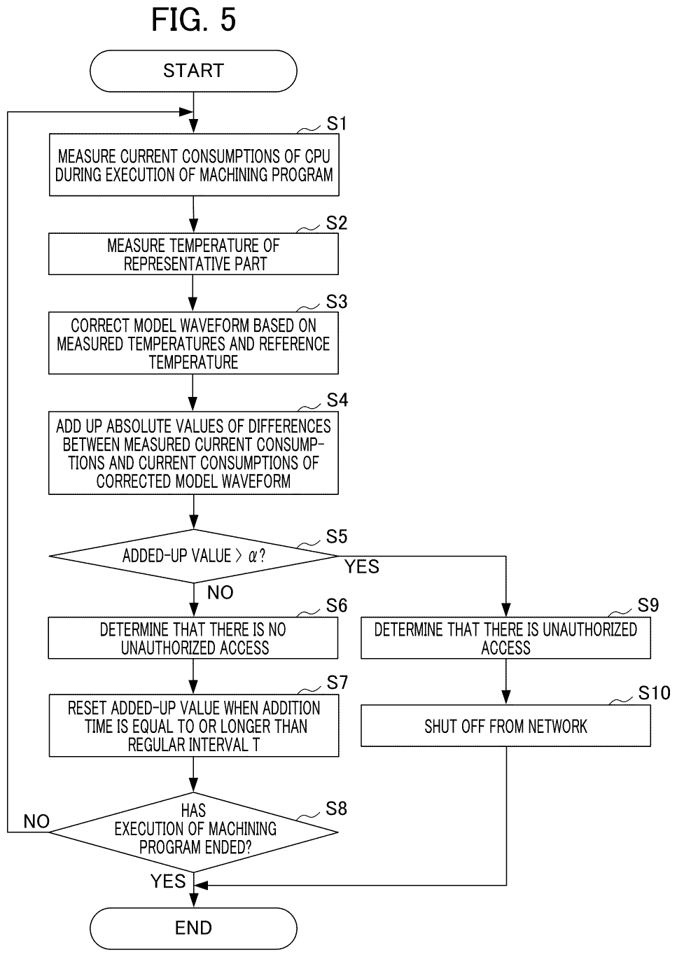

Next, a flow of a detection process of the numerical control device 10 will be described with reference to FIG. 5.

FIG. 5 is a flowchart illustrating the detection process of the numerical control device 10. The flow shown here is repeatedly executed each time the machining program is executed.

At Step S1, the measurement unit 130 measures the current consumption of the CPU 13 in sampling cycles using the ammeter not shown, which is arranged on the power source 23.

At Step S2, using the temperature sensor (not shown) or the like arranged on the representative part of the numerical control device 10 set in advance, the measurement unit 130 measures the temperature of the representative part of the numerical control device 10.

At Step S3, the correction unit 131 corrects the model waveform of the current consumption of the CPU 13 based on the temperature measured at Step S2 and the reference temperature recorded in the memory 12.

At Step S4, the detection unit 132 adds up absolute values of differences between current consumptions of the CPU 13 measured in association with the sampling cycles at Step S1 and current consumptions of the model waveform corrected at Step S3, the current consumptions corresponding to the sampling cycles in which the current consumptions have been measured at Step S1.

At Step S5, the detection unit 132 determines whether the added-up value obtained at Step S4 exceeds the determination threshold α or not. If the added-up value exceeds the determination threshold α, the process proceeds to Step S9. On the other hand, if the added-up value is equal to or less than the determination threshold α, the process proceeds to Step S6.

At Step S6, the detection unit 132 determines that there is no unauthorized access such as a DOS attack.

At Step S7, the detection unit 132 determines whether the time of addition is equal to or longer than the regular interval T or not, and, if the time of addition is equal to or longer than the regular interval T, resets the time of addition and the added-up value to “0”.

At Step S8, the detection unit 132 determines whether execution of the machining program has ended or not. If execution of the machining program has ended, the numerical control device 10 ends the detection process. On the other hand, if execution of the machining program has not ended, the process returns to Step S1.

At Step S9, the detection unit 132 determines there is unauthorized access such as a Dos attack.

At Step S10, the operation control unit 133 shuts off the numerical control device 10 from the network 20. Then, the operation control unit 133 stops the machining program and records a log to the effect that the unauthorized access such as a DOS attack has been detected, in the memory 12. Further, the operation control unit 133 displays (notifies) a message or the like that the unauthorized access has been detected, on the display unit the numerical control device 10 or the machine tool (not shown). Then, the numerical control device 10 ends the detection process.

As described above, by utilizing fluctuation in the current consumption of the CPU 13 that is actually operating, the numerical control device 10 according to the one embodiment can easily detect unauthorized access that disturbs operation of the numerical control device 10 or the network 20 by imposing an excessive load on resources, such as a DoS attack utilizing unknown vulnerability that has not been recognized.

Further, even if the physical state of an electronic component changes due to temperature change, the numerical control device 10 can prevent erroneous determination of unauthorized access, by correcting the model waveform of the physical state based on a measured temperature of the representative part of the numerical control device 10 and the reference temperature.

One embodiment has been described above. The numerical control device 10, however, is not limited to the embodiment described above, and modifications, improvements, and the like to the extent that the object can be achieved are included.

### Modification Example 1

Though the measurement unit 130 measures the current consumption of the CPU 13 in sampling cycles in the one embodiment, the present invention is not limited thereto. For example, the measurement unit 130 may measure the power consumption of the CPU 13 or the junction temperature of the CPU 13 in sampling cycles.

For example, in the case of the power consumption, since the power source 23 that supplies power to the CPU 13 is generally a constant-voltage power supply, and voltage V is constant, power consumption P shows change similar to that of current consumption I because of the relationship of P=V×I. Thereby, similarly to the case of the current consumption, the detection unit 132 can detect unauthorized access such as a DOS attack using the power consumption of the CPU 13 measured by the measurement unit 130.

Further, in the case of the junction temperature, since the electronic components including the CPU 13 generate heat due to power consumed by the electronic components, junction temperature Tj shows change similar to that of the power consumption P (that is, the current consumption I) because of the relationship of Tj=P×R_{JA}+Ta. Here, R_{JA} indicates the thermal resistance of the electronic components, and Ta indicates ambient temperature. Thereby, similarly to the case of current consumption, the detection unit 132 can detect unauthorized access such as a Dos attack using the junction temperature of the CPU 13 measured by the measurement unit 130.

### Modification Example 2

Further, for example, though the detection unit 132 adds up absolute values of differences between current consumptions of the CPU 13 measured by the measurement unit 130 in association with sampling cycles during the period of execution of the machining program and current consumptions of a model waveform corrected by the correction unit 131, the current consumptions corresponding to the sampling cycles in which the current consumptions have been measured, at each regular interval T during each execution time of the machining program in the above embodiment, the present invention is not limited thereto. For example, the detection unit 132 may detect unauthorized access such as a DOS attack by adding up absolute values of differences between current consumptions of the CPU 13 measured by the measurement unit 130 in association with sampling cycles during standby and current consumptions of a model waveform of the current consumption of the CPU 13 in the normal state during the standby corrected by the correction unit 131, the current consumptions corresponding to the sampling cycles in which the current consumptions have been measured, at each regular interval T during the standby and determining whether an added-up value exceeds the determination threshold α or not.

That is, for example, even during standby (not performing machining) because of exchange of a workpiece to be machined, change in the machining program or the like, since the numerical control device 10 (the CPU 13) is executing a program to be the basis of operation and the like, the measurement unit 130 can measure the current consumption of the CPU 13 and the temperature of a representative part of the numerical control device 10 set in advance, during the standby, and the correction unit 131 can correct the model waveform of the current consumption of the CPU 13 during the standby, based on the temperature of the representative part of the numerical control device 10 measured by the measurement unit 130 and the reference temperature recorded in the memory 12.

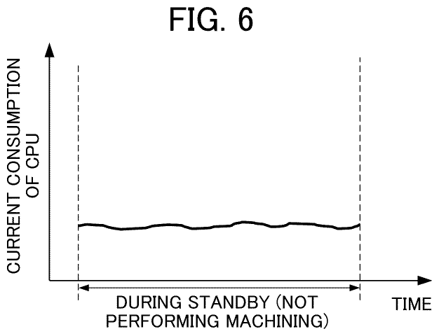

FIG. 6 is a diagram showing an example of the model waveform during standby.

Thereby, similarly to the case of the period of execution of the machining program, the detection unit 132 can detect unauthorized access such as a Dos attack, using current consumptions of the CPU 13 measured by the measurement unit 130 in association with sampling cycles, during standby, and the model waveform of the current consumption of the CPU 13 in the normal state during the standby, which has been corrected by the correction unit 131.

### Modification Example 3

For example, though the detection unit 132 detects unauthorized access such as a Dos attack based on the current consumption of the CPU 13 in the above embodiment, the present invention is not limited thereto. For example, the detection unit 132 may detect unauthorized access such as a DOS attack based on the current consumption, power consumption, or junction temperature of at least one electronic component such as the external I/F 11, the memory 12, the CPU 13, or the ASIC 14.

Each of functions included in the numerical control device 10 according to the one embodiment can be realized by hardware, software, or a combination thereof. Here, being realized by software means being realized by a computer reading and executing a program.

The program can be saved using various types of non-transitory computer readable media and be supplied to the computer. The non-transitory computer readable media include various types of tangible storage media. Examples of the non-transitory computer readable media include magnetic recording media (e.g., a flexible disk, a magnetic tape, and a hard disk drive), magnetic optical recording media (e.g., a magnetic optical disk), a CD-read only memory (CD-ROM), a CD-R, a CD-R/W, and semiconductor memories (e.g., a mask ROM, a programmable ROM (PROM), an erasable PROM (EPROM), a flash ROM, and a RAM). The program may be supplied to the computer by means of various types of transitory computer readable media. Examples of the transitory computer readable media include an electric signal, an optical signal, and an electromagnetic wave. The transitory computer readable medium can supply the program to the computer via a wired communication path such as an electric wire or an optical fiber or a wireless communication path.

Steps of describing the program recorded in a recording medium include not only processes that are performed in time series in the order thereof but also processes that are not necessarily performed in time series but are executed in parallel or individually.

In other words, a control device and a control method of the present disclosure can take various kinds of embodiments having the following configurations.
(1) A numerical control device 10 of the present disclosure is a control device capable of controlling an industrial machine and connecting to an external device, the control device including: a measurement unit 130 configured to measure a physical state of at least one electronic component in measurement cycles and measures temperature of a representative part set in advance; a memory 12 configured to record physical states of the electronic component during a period of execution of an arbitrary operation program and/or during standby in a normal state in association with the measurement cycles as a model waveform, and record the temperature of the representative part measured at time of recording the model waveform, as a reference temperature; a correction unit 131 configured to correct during the period of execution of the arbitrary operation program or during the standby, the model waveform of the electronic component recorded in the memory 12, based on the temperature of the representative part measured by the measurement unit 130 and the reference temperature; and a detection unit 132 configured to add up absolute values of differences between the physical states of the electronic component measured in association with the measurement cycles by the measurement unit 130 and physical states of the model waveform corrected by the correction unit 131, the physical states corresponding to the measurement cycles in which the physical states of the electronic component have been measured, at each regular interval during the period of execution of the arbitrary operation program or during the standby, and determine whether or not an added-up value exceeds a determination threshold set in advance in relation to unauthorized access that disturbs operation of the numerical control device 10 or a network 20 by imposing an excessive load on resources.

According to the numerical control device 10, it is possible to easily detect unauthorized access that disturbs operation of the numerical control device 10 and the network 20 by imposing an excessive load on resources, such as a DoS attack.
(2) In the numerical control device 10 described in (1), the physical state may be current consumption of the electronic component.

Thereby, the numerical control device 10 can accurately detect unauthorized access such as a DOS attack.
(3) In the numerical control device 10 described in (1), the physical state may be power consumption of the electronic component.

Thereby, the numerical control device 10 can have an advantageous effect similar to that of (2).
(4) In the numerical control device 10 described in (1), the physical state may be junction temperature of the electronic component.

Thereby, the numerical control device 10 can have an advantageous effect similar to that of (2).
(5) In the numerical control device 10 described in any of (1) to (4), the electronic component may include the CPU 13.

Thereby, the numerical control device 10 can quickly detect unauthorized access such as a DOS attack.
(6) The numerical control device 10 described in any of (1) to (5) may further include an operation control unit 133 configured to, when the detection unit 132 makes a determination of the unauthorized access, shut off at least the numerical control device 10 from the network 20, stop the operation program, and record a log to the effect that the unauthorized access has been detected, to the memory 12.

Thereby, the numerical control device 10 can avoid the impact of the unauthorized access such as a Dos attack.
(7) A control method of the present disclosure is a method for controlling an industrial machine by a control device capable of connecting to an external device, the method including: a measurement step of measuring a physical state of at least one electronic component in measurement cycles and measuring temperature of a representative part set in advance; a recording step of recording physical states of the electronic component during a period of execution of an arbitrary operation program and/or during standby in association with the measurement cycles as a model waveform, and recording the temperature of the representative part measured at time of recording the model waveform, as a reference temperature; a correction step of correcting the recorded model waveform of the electronic component during the period of execution of the arbitrary operation program or during the standby, based on the measured temperature of the representative part and the reference temperature; and a detection step of adding up absolute values of differences between the measured physical states of the electronic component in association with the measurement cycles and physical states of the corrected model waveform, the physical states corresponding to the measurement cycles in which the physical states of the electronic component have been measured, at each regular interval during the period of the execution of the arbitrary operation program or during the standby, and determining whether or not an added-up value exceeds a determination threshold set in advance in relation to unauthorized access that disturbs operation of the numerical control device 10 or a network 20 by imposing an excessive load on resources.

According to this control method, an advantageous effect similar to (1) can be obtained.

### EXPLANATION OF REFERENCE NUMERALS

1 Control system
10 Numerical control device
11 External I/F
12 Memory
13 CPU
130 Measurement unit
131 Correction unit
132 Detection unit
133 Operation control unit
14 ASIC
20 Network
21 to 24 Power source

1. A control device capable of controlling an industrial machine and connecting to an external device, the control device comprising:
a measurement unit configured to measure a physical state of at least one electronic component in measurement cycles and measures temperature of a representative part set in advance;
a recording unit configured to record physical states of the electronic component during a period of execution of an arbitrary operation program and/or during standby in a normal state in association with the measurement cycles as a model waveform, and record the temperature of the representative part measured at time of recording the model waveform, as a reference temperature;
a correction unit configured to correct, during the period of execution of the arbitrary operation program or during the standby, the model waveform of the electronic component recorded in the recording unit, based on the temperature of the representative part measured by the measurement unit and the reference temperature; and
a detection unit configured to add up absolute values of differences between the physical states of the electronic component measured in association with the measurement cycles by the measurement unit and physical states of the model waveform corrected by the correction unit, the physical states corresponding to the measurement cycles in which the physical states of the electronic component have been measured, at each regular interval during the period of execution of the arbitrary operation program or during the standby, and determine whether or not an added-up value exceeds a determination threshold set in advance in relation to unauthorized access that disturbs operation of the control device or a network by imposing an excessive load on resources.

2. The control device according to claim 1, wherein the physical state is current consumption of the electronic component.

3. The control device according to claim 1, wherein the physical state is power consumption of the electronic component.

4. The control device according to claim 1, wherein the physical state is junction temperature of the electronic component.

5. The control device according to claim 1, wherein the electronic component includes a processor.

6. The control device according to claim 1, further comprising an operation control unit configured to, when the detection unit makes a determination of the unauthorized access, shut off at least the control device from the network, stop the operation program, and record a log to the effect that the unauthorized access has been detected, in the recording unit.

7. A method for controlling an industrial machine by a control device capable of connecting to an external device, the method comprising:
a measurement step of measuring a physical state of at least one electronic component in measurement cycles and measuring temperature of a representative part set in advance;
a recording step of recording physical states of the electronic component during a period of execution of an arbitrary operation program and/or during standby in a normal state in association with the measurement cycles as a model waveform, and recording the temperature of the representative part measured at time of recording the model waveform, as a reference temperature;
a correction step of correcting the recorded model waveform of the electronic component during the period of execution of the arbitrary operation program or during the standby, based on the measured temperature of the representative part and the reference temperature; and
a detection step of adding up absolute values of differences between the physical states of the electronic component measured in association with the measurement cycles and physical states of the corrected model waveform, the physical states corresponding to the measurement cycles in which the physical states of the electronic component have been measured, at each regular interval during the period of execution of the arbitrary operation program or during the standby, and determining whether or not an added-up value exceeds a determination threshold set in advance in relation to unauthorized access that disturbs operation of the control device or a network by imposing an excessive load on resources.
